(19) United States
(12) Patent Application Publication
(10) Pub. No.: US 2019/0263394 A1
(43) Pub. Date: Aug. 29, 2019

(54) METHOD OF CONTROLLING A VEHICLE

(71) Applicant: TRW Automotive U.S. LLC, Livonia, OH (US)

(72) Inventor: Daniel E. Williams, Carmel, IN (US)

(21) Appl. No.: 16/317,040

(22) PCT Filed: Aug. 28, 2017
(86) PCT No.: PCT/US2017/048821

§ 371 Date: Jan. 11, 2019

Related U.S. Application Data
(60) Provisional application No. 62/379,765, filed on Aug. 26, 2016.

(51) Int. Cl. B60W 30/09; B60T 7/12; B60W 30/095; B62D 15/02; B60K 31/00

(52) U.S. Cl. CPC B60W 30/09; B60T 7/12; B60W 30/0956; B60W 2520/10; B60K 31/0008; B60W 2520/06; B62D 15/0265

(57) ABSTRACT

A method of controlling a vehicle includes determining location, speed, and direction of travel of the vehicle. At least one vehicle condition is sensed. A desired trajectory for the vehicle is determined in response to the sensed vehicle condition. A center point of an artificial stiffness applied to a steering wheel of the vehicle is varied so that the desired trajectory becomes the center point of the artificial stiffness. The artificial stiffness applied to the steering wheel is increased in response to an initiated steering maneuver. An apparatus for controlling a vehicle includes a steering system for turning steerable vehicle wheels of the vehicle in response to rotation of a steering wheel of the vehicle. A first sensor senses a location, speed, and direction of travel of the vehicle. A second sensor senses at least one vehicle condition. A controller that receives signals from the first and second sensors determines a desired trajectory for the vehicle in response to first and second signals received from the first and second sensors and varies a center point of an artificial stiffness applied to the steering wheel of the vehicle so that the desired trajectory becomes the center point of the artificial stiffness and increases the artificial stiffness applied to the steering wheel in response to an initiated steering maneuver.

### RELATED APPLICATIONS

This application claims the benefit of U.S. Provisional Application Ser. No. 62/379,765, filed Aug. 26, 2016 the entirety of which is incorporated herein by reference.

### FIELD OF THE INVENTION

The present invention is directed to an apparatus and method for use in controlling a vehicle and, specifically, to an apparatus and method for use in controlling the steering of a vehicle in response to a sensed vehicle condition, such as an automatic emergency braking or the proximity of a geo fence.

### BACKGROUND OF THE INVENTION

A known system and method for controlling a vehicle includes a coordinated braking and steering response to a slow or stopped vehicle in a lane being overtaken by the vehicle with the known system. The system calculates the correct response of steering and/or braking, depending on the states of the two vehicles, friction of the road surface, etc. The system then applies the correct steering and/or braking to the vehicle to change lanes and avoid a collision with the slow or stopped vehicle. The operator of the vehicle may initiate the lane change, but the system then takes over to complete the correct steering and/or braking to complete the lane change.

Another known system and method for controlling a vehicle includes defining geographically excluded areas of vehicle operation and controlling speed of the vehicle by throttling the engine, using a speed limiting message, and/or applying the vehicle brakes.

Another known system and method for controlling a vehicle includes disabling or partially disabling a vehicle in response to a high risk driver. Vehicle parameters may trigger control and driver feedback intervention. A GPS module may monitor vehicle speed, location, and acceleration. If defined geo-fence boundaries are exceeded, the vehicle speed may be reduced and/or the vehicle direction may be altered.

### SUMMARY OF THE INVENTION

A method of controlling a vehicle includes determining location, speed, and direction of travel of the vehicle. At least one vehicle condition is sensed. A desired trajectory for the vehicle is determined in response to the sensed vehicle condition. A center point of an artificial stiffness applied to a steering wheel of the vehicle is varied so that the desired trajectory becomes the center point of the artificial stiffness. The artificial stiffness applied to the steering wheel is increased in response to an initiated steering maneuver.

In another aspect of the invention, an apparatus for controlling a vehicle includes a steering system for turning steerable vehicle wheels of the vehicle in response to rotation of a steering wheel of the vehicle. A first sensor senses a location, speed, and direction of travel of the vehicle. A second sensor senses at least one vehicle condition. A controller that receives signals from the first and second sensors determines a desired trajectory for the vehicle in response to first and second signals received from the first and second sensors and varies a center point of an artificial stiffness applied to the steering wheel of the vehicle so that the desired trajectory becomes the center point of the artificial stiffness and increases the artificial stiffness applied to the steering wheel in response to an initiated steering maneuver.

### BRIEF DESCRIPTION OF THE DRAWING

The foregoing and other features of the present invention will become apparent to those skilled in the art to which the present invention relates upon reading the following description with reference to the accompanying drawing, in which:

FIG. 1 is a schematic view of a vehicle having an apparatus for controlling the vehicle constructed in accordance with the present invention.

### DESCRIPTION

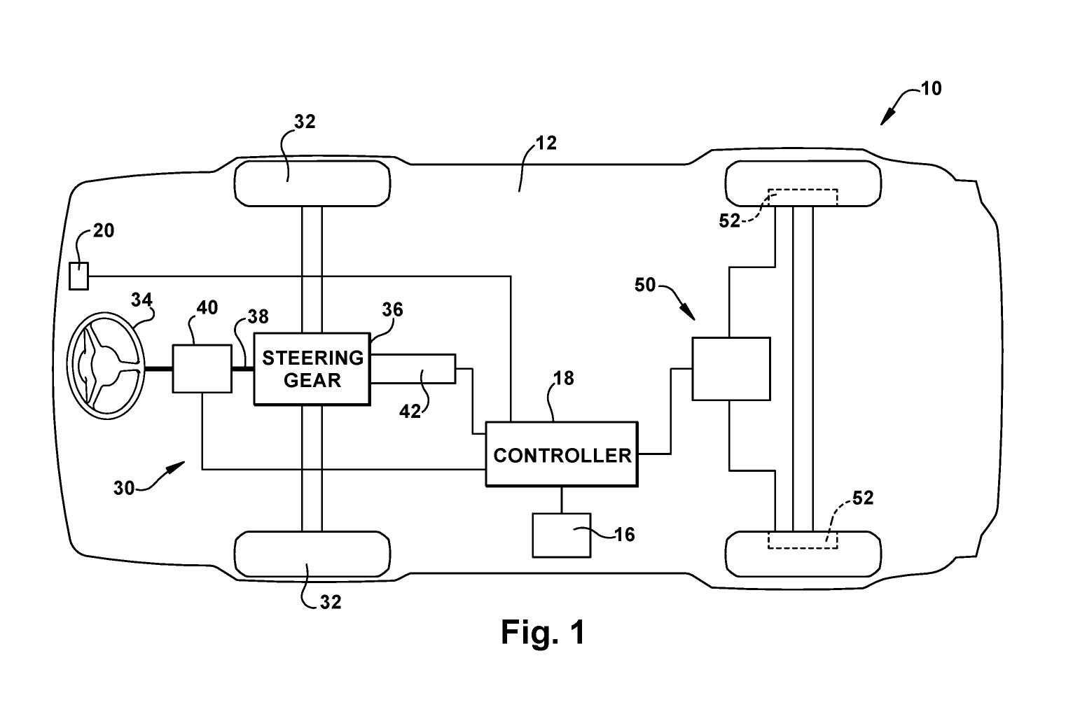

The present invention is directed to an apparatus and method for controlling the steering of a vehicle in response to a vehicle condition. An apparatus or system 10 for controlling a vehicle 12 constructed in accordance with the present invention is illustrated in FIG. 1. The apparatus 10 may include a first vehicle condition sensor 16 that indicates the location, speed, and direction of travel of the vehicle. The first vehicle condition sensor 16 transmits a first signal to a controller 18 for controlling steering of the vehicle 12. The first sensor 16 may use any desired system, such as a Global Positioning System (GPS) to determine the position of the vehicle, direction of travel and speed as known in the art.

A second vehicle condition sensor 20 attached to the vehicle 12 may be used to determine the position of the vehicle relative to a roadway, lane of the roadway, and/or another vehicle. The second sensor 20 may also determine a speed of the vehicle 10 and another vehicle. The second sensor 20 transmits at least one signal to the controller 18. The second sensor may be a Driver Assist System (DAS) having at least one camera as known in the art.

The controller 18 determines a desired trajectory of travel for the vehicle 12 in response to the signals from the first and second sensors 16, 20. The desired trajectory may be a path that prevents the vehicle from colliding with another vehicle. The steering position associated with the desired trajectory becomes the center point of an artificial or synthetic stiffness of a steering system 30 of the vehicle 12 as described in U.S. Pat. Nos. 6,546,322 and/or 5,709,281, which are incorporated herein by reference in their entirety. The controller 18 sends a signal to the steering system 30 of the vehicle 12 to adjust the steering direction, steering feel and/or steering torque felt by an operator of the vehicle.

The steering system 30 turns steerable vehicle wheels 32 of the vehicle 12 in response to rotation of a steering wheel 34 of the vehicle. The steering wheel 34 is connected to a steering gear 36 by at least one shaft 38 so that rotation of the steering wheel actuates the steering gear 36 to turn the steerable vehicle wheels 32. A motor 40 is connected to the shaft 38. The motor 40 may apply a torque to rotate the shaft 38 in response to a signal received from the controller 18. The motor 40 may apply a torque to the shaft 38 to provide a desired steering feel and/or steering torque felt by the operator of the vehicle.

The steering system 30 may also include a plurality of other vehicle condition sensors (not shown). The other vehicle condition sensors may include a lateral acceleration sensor and a steering wheel rotation sensor. The lateral acceleration sensor may continuously sense the lateral acceleration of the vehicle and generate an electrical signal indicative of the sensed lateral acceleration. The steering wheel rotation sensor may continuously sense the magnitude, rate, and acceleration of rotation of the vehicle steering wheel 34 and generate electrical signals indicative of these parameters. The controller 18 receives the signals generated by the lateral acceleration sensor and the steering wheel rotation sensor. Additionally, the controller 18 may receive a column torque signal from a torque sensor 42 connected with the shaft 38. The controller 18 analyzes the respective signals and generates a signal for controlling the motor 40. As a result, the motor 40 assists the operator in controlling the steering gear 36 to provide a desired steering assist and results in a desired steering feel to the operator.

A desired steering feel algorithm may vary the center point of a synthetic stiffness felt by the operator of the vehicle 12 by controlling the torque applied by the motor 40 to the shaft 38. The center point of the synthetic stiffness is determined in response to the vehicle condition sensors 16, 20, and may be useful to compensate for side winds and road crown that change the effective center point of the steering system during normal operation of the vehicle 12. The operator of the vehicle 12 can still easily turn the steering wheel 34 away from the center point of the synthetic stiffness. The motor 40 urges the steering wheel 34 back toward the center point of the synthetic stiffness with a desired stiffness.

The apparatus 10 may also include an automatic emergency braking (AEB) system 50 that may send a collision signal to the operator of the vehicle, such as an audible or visual signal, that a collision is possible. The AEB system 50 may use data provided by the sensor 20 to determine if a collision is possible. The AEB system 50 may automatically engage vehicle brakes 52 to decelerate the vehicle 12 when the AEB system determines that a collision is possible. The AEB system also sends a signal to the controller 18 that the AEB system has applied the brakes.

The operator of the vehicle 12 may initiate a steering maneuver in response to the collision signal and/or the AEB system 50 engaging the vehicle brakes 52. The controller 18 may increase the artificial stiffness applied to the steering wheel 34 by the motor 40 in response to the initiated steering maneuver and the collision signal. The controller 18 may also calculate a desired trajectory for the vehicle 12 or an optimal lane change to avoid the possible collision and avoid vehicle rollover from a sudden change of direction of the vehicle. Therefore, the increased artificial stiffness urges the steering wheel 34 toward the desired trajectory or the calculated optimal lane change trajectory.

The center point of the synthetic stiffness may be varied based on information on the other vehicle as well as the vehicle 12 and the vehicle speed. When the operator decides to avoid the other vehicle through a lane change maneuver, the steering system 30 receives the desired trajectory from the controller 18, and varies the center point of the synthetic stiffness. The stiffness about the center point may be varied to increasingly urge the operator to follow the desired trajectory. At all times, if the operator does not want to follow the desired trajectory suggested by the controller 18, the synthetic stiffness may be overcome by the operator. Therefore, the desired trajectory may be tracked with a varying degree of stiffness while still allowing driver control of the vehicle.

The controller 18 may also define at least one geo-fence. The geo-fence may define allowed distances between vehicles and allowed distances between vehicles and other structures, such as buildings, light posts, cliffs, and/or ditches. The controller 18 determines an anticipated trajectory of the vehicle and/or the proximity of the vehicle to the geo-fences in response to the signal from the first sensor 16 and/or the second sensor 20. The controller 18 may transmit a signal to the steering system 30 of the vehicle 12 to adjust the steering direction, steering feel and/or steering torque felt by the operator of the vehicle.

If a geo-fenced area is in the anticipated trajectory of the vehicle, a desired or alternate trajectory that avoids the geo-fenced area is computed. The steering position associated with the desired trajectory becomes the center point of the synthetic stiffness of the steering system 30.

An auxiliary steering wheel torque is a function of the lateral distance from the vehicle 12 to a geo-fenced area. Such a function could be: T=C₁xₗₐₜ+C₂\dot{x}ₗₐₜ+C₃\ddot{x}ₗₐₜ where Cᵢ are constants to be tuned and xₗₐₜ is the lateral distance from the vehicle 12 to the geo-fence.

If the vehicle 12 violates a geo-fenced boundary, the controller 18 may transmit a signal to the vehicle brakes 52 to slow or stop the vehicle. The controller 18 may determine the trajectory to most quickly remove the vehicle 12 from an excluded area. The controller 18 may also transmit a signal to adjust the position of the steering wheel 34 to put the vehicle 12 on a desired trajectory to most quickly remove the vehicle from the excluded area. The steering wheel 34 may move in response to the signal and/or the steering feel may be adjusted to cause an operator of the vehicle to steer the vehicle along the desired trajectory.

The apparatus and method may be used to maneuver vehicles, such as semi-tractors and trucks, in parking lots and factory and depot loading and unloading areas. The apparatus and method may exclude vehicles from passenger car parking lots, light poles, physical fences and barriers, buildings, etc. At a mine site, physical cliffs could be excluded. At a factory site a truck might need to have specific permission to enter a protected lot. At a construction site, areas could be defined to be off-limits for trucks.

The apparatus and method may be used to control one or more vehicles in response to each other and one or more geo-fenced areas.

Although the controller 18 is illustrated as being connected to the vehicle 12, it is contemplated that the controller may be located away from the vehicle. The controller 18 may communicate wirelessly with the steering system 30 and vehicle condition sensors 16, 20 if located away from the vehicle.

Having described the invention, the following is claimed:

1. A method of controlling a vehicle, comprising:
determining location, speed, and direction of travel of the vehicle;
sensing at least one vehicle condition;
determining a desired trajectory for the vehicle in response to the sensed vehicle condition;
varying a center point of an artificial stiffness applied to a steering wheel of the vehicle so that the desired trajectory becomes the center point of the artificial stiffness; and
increasing the artificial stiffness applied to the steering wheel in response to an initiated steering maneuver.

2. A method as set forth in claim 1 wherein sensing at least one vehicle condition includes sensing a possibility of a vehicle collision.

3. A method as set forth in claim 2 including transmitting a collision signal provided by an automatic emergency braking (AEB) system to avoid a possible collision and avoid vehicle rollover from a sudden change of direction of the vehicle.

4. A method as set forth in claim 1 wherein sensing the at least one vehicle condition includes sensing the location of the vehicle with respect to a geo-fence.

5. A method as set forth in claim 4 wherein determining the desired trajectory includes determining the trajectory to most quickly remove the vehicle from an excluded area defined by the geo-fence.

6. A method as set forth in claim 4 wherein sensing at least one vehicle condition includes sensing a possibility of a vehicle collision.

7. A method as set forth in claim 1 wherein varying the center point of the artificial stiffness applied to a steering wheel of the vehicle includes applying torque to a steering shaft with a motor.

8. An apparatus for controlling a vehicle, comprising:
a steering system for turning steerable vehicle wheels of the vehicle in response to rotation of a steering wheel of the vehicle;
a first sensor that senses a location, speed, and direction of travel of the vehicle;
a second sensor that senses at least one vehicle condition; and
a controller that receives signals from the first and second sensors, the controller determining a desired trajectory for the vehicle in response to first and second signals received from the first and second sensors and varying a center point of an artificial stiffness applied to the steering wheel of the vehicle so that the desired trajectory becomes the center point of the artificial stiffness and increasing the artificial stiffness applied to the steering wheel in response to an initiated steering maneuver.

9. An apparatus as set forth in claim 8 further including an automatic emergency braking (AEB) system that transmits a collision signal to the controller in response to detecting a possible collision, the controller determining a desired trajectory for the vehicle to help avoid a possible collision and avoid vehicle rollover from a sudden change of direction of the vehicle.

10. An apparatus as set forth in claim 8 wherein the second sensor senses the location of the vehicle with respect to a geo-fence and the controller determines the trajectory to most quickly remove the vehicle from an excluded area defined by the geo-fence.

11. An apparatus as set forth in claim 8 wherein the steering system includes a motor connected with a steering shaft connected with the steering wheel, the motor applying a torque to the steering shaft, the controller being connected with the motor and controlling the torque applied by the motor to the shaft to vary a center point of the artificial stiffness.
